(19) United States
(12) Patent Application Publication
(10) Pub. No.: US 2026/0185386 A1
(43) Pub. Date: Jul. 2, 2026

(54) DECOUPLING POWER RELEASE MECHANISM FOR VEHICLE LATCH

(71) Applicant: INTEVA PRODUCTS, LLC, Troy, MI (US)

(72) Inventors: Francisco Javier Vazquez, Cd. Juarez (MX); Carlos Isaac Tostado Bocanegra, Cd. Juarez (MX); Jesus Eli Calamaco, Cd. Juarez (MX); Silverio Hernandez Sanchez, Cd. Juarez (MX)

(21) Appl. No.: 19/400,515

(22) Filed: Nov. 25, 2025

Related U.S. Application Data
(60) Provisional application No. 63/741,411, filed on Jan. 2, 2025.
(60) Provisional application No. 63/764,750, filed on Feb. 28, 2025.

(51) Int. Cl. E05B 81/14; E05B 81/06; E05B 81/30; E05B 81/34; E05B 81/42

(52) U.S. Cl. CPC E05B 81/14; E05B 81/06; E05B 81/30; E05B 81/34; E05B 81/42

(57) ABSTRACT

A vehicle door latch, including: a power release mechanism for transitioning the vehicle latch from a latched state to an unlatched state, the power release mechanism including: a motor that rotates a worm, the worm when rotated, causes rotation of a power release gear, the power release gear when rotated moves and contacts a power release lever that is operably coupled to the power release gear and the power release lever is operably coupled to a pawl of the latch, the pawl being configured for movement between an engaged position and disengaged position, the pawl when in the engaged position prevents a claw of the latch from moving from a latched position to an unlatched position and when the pawl is moved to the disengaged position the claw is free to move from the latched position to the unlatched position, the power release gear has a cam surface that moves the power release lever when the power release gear is rotated; and a detent link pivotally mounted to the power release lever, the detent link capable of being moved between at least an engaged position where it is configured to contact and move a detent lever pivotally mounted to a housing of the latch, the detent lever being operably coupled to the pawl such that movement of the detent lever will cause the pawl to move from the engaged position to the disengaged position, the detent link when in a disengaged position does not contact or move the detent lever.

### CROSS REFERENCE TO RELATED APPLICATIONS

The present application claims the benefit of the following patent applications U.S. Provisional Patent Application No. 63/741,411 filed on Jan. 2, 2025 and U.S. Provisional Patent Application No. 63/764,750 filed on Feb. 28, 2025 the contents each of which are incorporated herein by reference thereto.

### TECHNICAL FIELD

Exemplary embodiments of the present disclosure pertain to the art of vehicle latches. More particularly, vehicle latches with a power release mechanism.

### BACKGROUND

In some applications, the vehicle latch must be configured to operate when the vehicle latch is no longer capable of being operated electrically. In other words, if the vehicle latch is damaged, or some components such as a motor are inoperable or have lost power, the vehicle latch must still be able to provide some essential functions.

In a vehicle door latch or vehicle door latch assembly it is desirable to provide the vehicle latch or vehicle latch assembly that offers many electrical and mechanical functions while maintaining a relatively small package with the ability of fitting on a variety of designs.

It is also desirable to provide a vehicle latch or vehicle latch assembly that provides numerous electrical and mechanical functions in certain vehicle conditions.

### BRIEF DESCRIPTION

Disclosed is a vehicle door latch, including: a power release mechanism for transitioning the vehicle door latch from a latched state to an unlatched state, the power release mechanism including: a motor that rotates a worm, the worm when rotated, causes rotation of a power release gear, the power release gear when rotated moves and contacts a power release lever that is operably coupled to the power release gear and the power release lever is operably coupled to a pawl of the vehicle door latch, the pawl being configured for movement between an engaged position and disengaged position, the pawl when in the engaged position prevents a claw of the vehicle door latch from moving from a latched position to an unlatched position and when the pawl is moved to the disengaged position the claw is free to move from the latched position to the unlatched position, the power release gear has a cam surface that moves the power release lever when the power release gear is rotated; and a detent link pivotally mounted to the power release lever, the detent link capable of being moved between at least an engaged position where it is configured to contact and move a detent lever pivotally mounted to a housing of the latch, the detent lever being operably coupled to the pawl such that movement of the detent lever will cause the pawl to move from the engaged position to the disengaged position, the detent link when in a disengaged position does not contact or move the detent lever.

In addition to one or more of the features described above, or as an alternative to any of the foregoing embodiments, movement of the detent link is facilitated by an override lever that moves a pin of the detent link that is slidably received within an elongated opening of the override lever.

In addition to one or more of the features described above, or as an alternative to any of the foregoing embodiments, movement of the override lever is facilitated by rotational movement of an override knob operably coupled to the override lever.

In addition to one or more of the features described above, or as an alternative to any of the foregoing embodiments, when the detent link is in the disengaged position, the detent lever is capable of independent movement with respect to the power release lever.

In addition to one or more of the features described above, or as an alternative to any of the foregoing embodiments, movement of the detent link is facilitated by an override lever that moves a pin of the detent link that is slidably received within an elongated opening of the override lever and movement of the override lever is facilitated by rotational movement of an override knob operably coupled to the override lever.

In addition to one or more of the features described above, or as an alternative to any of the foregoing embodiments, the power release lever is pivotally mounted to the housing of the vehicle door latch.

In addition to one or more of the features described above, or as an alternative to any of the foregoing embodiments, the power release lever and the detent lever rotate about the same axis.

In addition to one or more of the features described above, or as an alternative to any of the foregoing embodiments, movement of the detent link is facilitated by an override lever that moves a pin of the detent link that is slidably received within an elongated opening of the override lever and movement of the override lever is facilitated by rotational movement of an override knob operably coupled to the override lever and when the detent link is in the disengaged position, the detent lever is capable of independent movement with respect to the power release lever.

Also disclosed is a power release mechanism for transitioning a vehicle latch from a latched state to an unlatched state, the power release mechanism including: a power release gear, the power release gear when rotated moves and contacts a power release lever that is operably coupled to the power release gear and the power release lever is operably coupled to a pawl of the vehicle latch, the pawl being configured for movement between an engaged position and disengaged position, the pawl when in the engaged position prevents a claw of the vehicle latch from moving from a latched position to an unlatched position and when the pawl is moved to the disengaged position the claw is free to move from the latched position to the unlatched position, the power release gear has a cam surface that moves the power release lever when the power release gear is rotated; and a detent link pivotally mounted to the power release lever, the detent link capable of being moved between at least an engaged position where it is configured to contact and move a detent lever, the detent lever being operably coupled to the pawl such that movement of the detent lever will cause the pawl to move from the engaged position to the disengaged position, the detent link when in a disengaged position does not contact or move the detent lever.

In addition to one or more of the features described above, or as an alternative to any of the foregoing embodiments, movement of the detent link is facilitated by an override lever that moves a pin of the detent link that is slidably received within an elongated opening of the override lever.

In addition to one or more of the features described above, or as an alternative to any of the foregoing embodiments, movement of the override lever is facilitated by rotational movement of an override knob operably coupled to the override lever.

In addition to one or more of the features described above, or as an alternative to any of the foregoing embodiments, the detent link is in the disengaged position, the detent lever is capable of independent movement with respect to the power release lever.

In addition to one or more of the features described above, or as an alternative to any of the foregoing embodiments, movement of the detent link is facilitated by an override lever that moves a pin of the detent link that is slidably received within an elongated opening of the override lever and movement of the override lever is facilitated by rotational movement of an override knob operably coupled to the override lever.

In addition to one or more of the features described above, or as an alternative to any of the foregoing embodiments, the power release lever and the detent lever rotate about the same axis and movement of the detent link is facilitated by an override lever that moves a pin of the detent link that is slidably received within an elongated opening of the override lever and movement of the override lever is facilitated by rotational movement of an override knob operably coupled to the override lever and when the detent link is in the disengaged position, the detent lever is capable of independent movement with respect to the power release lever.

Also disclosed is a vehicle door latch, including: a power release mechanism for transitioning the vehicle door latch from a latched state to an unlatched state, the power release mechanism including: a motor that rotates a worm, the worm when rotated, causes rotation of a power release gear, the power release gear when rotated moves and contacts a power release lever that is operably coupled to the power release gear and the power release lever is operably coupled to one of a primary pawl and a secondary pawl of the vehicle door latch, the primary pawl being configured for movement between an engaged position and a disengaged position, the primary pawl when in the engaged position prevents a claw of the vehicle door latch from moving from a latched position to an unlatched position and when the primary pawl is moved to the disengaged position the claw is free to move from the latched position to the unlatched position, the power release gear has a cam surface that moves the power release lever when the power release gear is rotated; and a detent link pivotally mounted to the power release lever, the detent link capable of being moved between at least an engaged position where the detent link is configured to contact and move a detent lever pivotally mounted to a housing of the latch, the detent lever being operably coupled to the secondary pawl such that movement of the detent lever will cause the secondary pawl to move the primary pawl from the engaged position to the disengaged position, the detent link when in a disengaged position does not contact or move the detent lever when the power release gear is rotated.

In addition to one or more of the features described above, or as an alternative to any of the foregoing embodiments, movement of the detent link is facilitated by an override lever that moves a pin of the detent link that is slidably received within an elongated opening of the override lever.

In addition to one or more of the features described above, or as an alternative to any of the foregoing embodiments, movement of the override lever is facilitated by rotational movement of an override knob operably coupled to the override lever.

In addition to one or more of the features described above, or as an alternative to any of the foregoing embodiments, when the detent link is in the disengaged position, the detent lever is capable of independent movement with respect to the power release lever.

In addition to one or more of the features described above, or as an alternative to any of the foregoing embodiments, movement of the detent link is facilitated by an override lever that moves a pin of the detent link that is slidably received within an elongated opening of the override lever and movement of the override lever is facilitated by rotational movement of an override knob operably coupled to the override lever.

In addition to one or more of the features described above, or as an alternative to any of the foregoing embodiments, the power release lever is pivotally mounted to the housing of the vehicle door latch and the power release lever and the detent lever rotate about the same axis.

Also disclosed is a method of disengaging a power release mechanism from a pawl or pawls of a vehicle latch in the event the power release mechanism becomes in operative, including disengaging a detent lever operably coupled to the pawl or pawls of the vehicle latch from a power release lever by moving a detent link rotatably mounted to the power release lever to a disengaged position such that the detent link no longer contacts the detent lever, wherein the detent lever is capable of independent movement with respect to the power release lever when the detent link is in the disengaged position.

### BRIEF DESCRIPTION OF THE DRAWINGS

The following descriptions should not be considered limiting in any way. With reference to the accompanying drawings, like elements are numbered alike:

FIG. 1 is a schematic illustration of a vehicle latch with a power release mechanism in accordance with the present disclosure;

FIG. 2 is an illustration of the power release mechanism in a home position and in an engaged position;

FIG. 3 is an illustration of the power release mechanism in a disengaged position;

FIG. 4 is an illustration of the power release mechanism in a power release position and in an engaged position;

FIG. 5 is an illustration of the power release mechanism in a power release in a disengaged position;

FIG. 6 is an illustration of the power release mechanism in an engaged position;

FIG. 7 is an illustration of the power release mechanism in a disengaged position;

FIG. 8 is an illustration of the power release mechanism in a power release in a disengaged position;

FIG. 9 is an illustration of the power release mechanism in a home position and in an engaged position;

FIG. 10 is an illustration of the power release mechanism in a home position and in an engaged position;

FIG. 11 is an illustration of the power release mechanism in a home position and the latch in a closed position;

FIG. 12 is an illustration of power release when the power release mechanism in an engaged position;

FIG. 13 is an illustration of power release when the power release mechanism in an engaged position;

FIG. 14 is an illustration of power release when the power release mechanism is in an engaged position;

FIG. 15 is an illustration of the power release mechanism in a home and a disengaged position;

FIG. 16 is an illustration of the power release mechanism in a home and disengaged position;

FIG. 17 is an illustration of the power release mechanism in a home position and a disengaged position;

FIG. 18 is an illustration of power release when the power release mechanism is in a disengaged position;

FIG. 19 is an illustration of power release when the power release mechanism is in a disengaged position; and

FIG. 20 is an illustration of power release when the power release mechanism is in a disengaged position.

### DETAILED DESCRIPTION

A detailed description of one or more embodiments of the disclosed apparatus and method are presented herein by way of exemplification and not limitation with reference to the Figures.

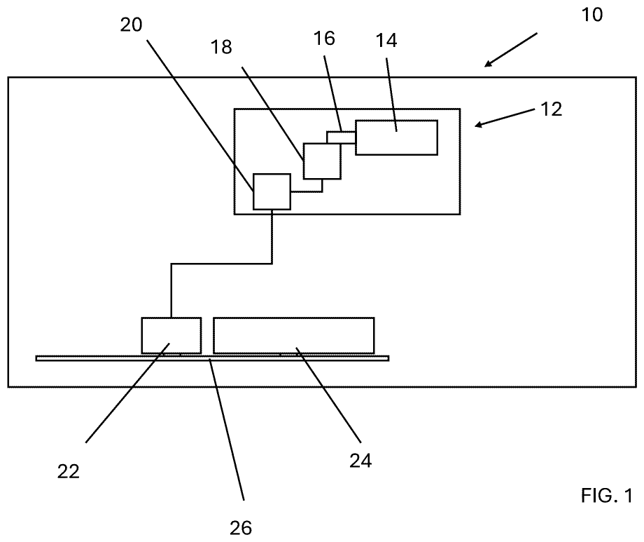

FIG. 1 schematically illustrates a vehicle door latch 10, which in one non-limiting embodiment may be a side door vehicle latch. The vehicle door latch 10 includes a power release mechanism 12 for transitioning the vehicle latch 10 from a latched state to an unlatched state. The power release mechanism 12 includes a motor 14 that rotates a worm 16, which when rotated, causes rotation of a power release gear or lever 18 that when rotated moves and contacts a power release lever 20 that is operably coupled to a pawl 22 of the latch. In one embodiment, the worm 16 is configured to meshingly engage teeth 15 of the power release gear 18. The pawl 22 is configured for movement between an engaged position and disengaged position, the pawl 22 when in the engaged position prevents a claw 24 from moving from a latched position to an unlatched position. When the pawl 22 is moved to the disengaged position the claw 24 is free to move from a latched position to an unlatched position. The pawl 22 and claw 24 in one non-limiting embodiment are rotatably mounted to a backing plate 26 of the vehicle latch 10. In one non-limiting embodiment, the pawl 22 is spring biased into the engaged position by a spring and the claw 24 is spring biased into the unlatched position by a spring.

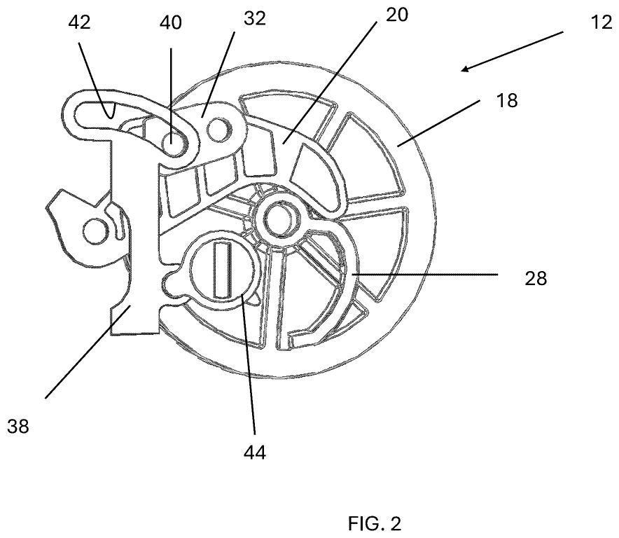

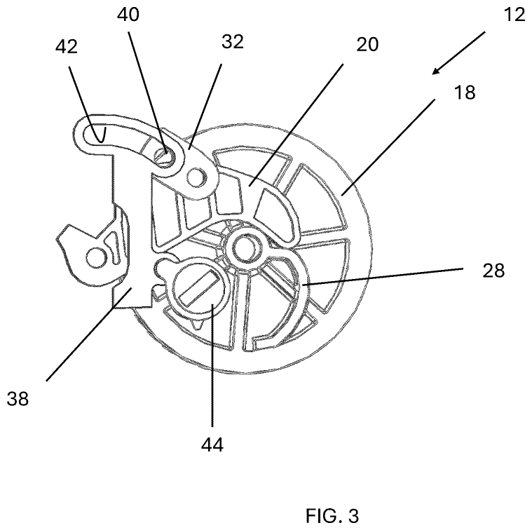

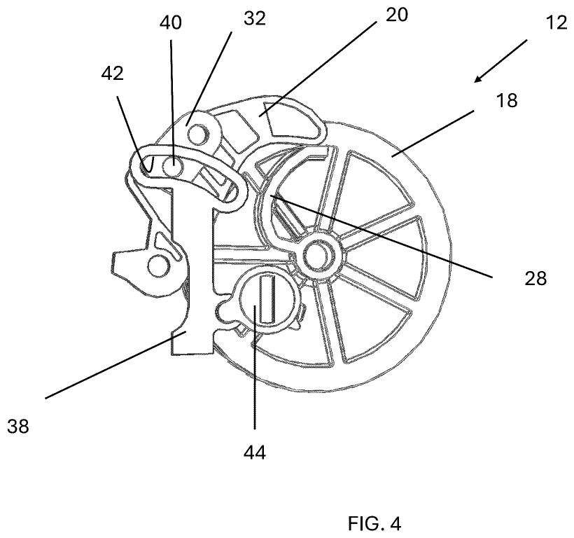

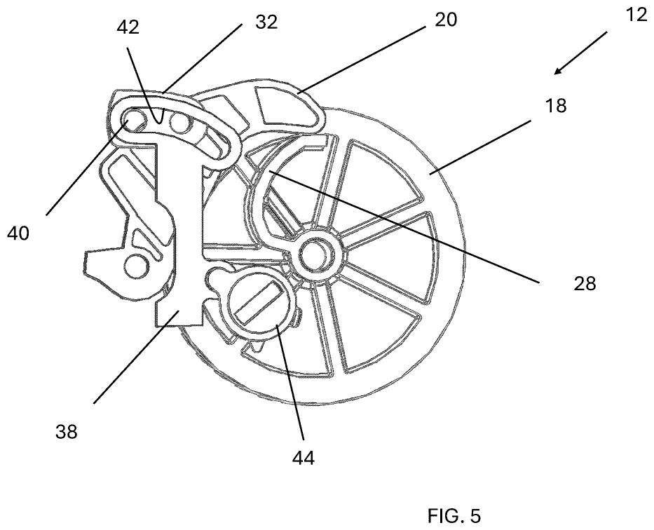

Referring now to at least FIGS. 1-20, the power release mechanism 12 is activated by the motor 14 that moves the power release gear 18. The power release gear 18 has a cam surface 28 that rotates at the same rate and velocity of the power release gear 18. The cam surface 28 moves the power release lever 20 which in one non-limiting embodiment may be spring loaded or biased which in turn moves with certain mechanical advantage one or more detent levers and ultimately pawl 22, operably coupled to the one or more detent levers, that keeps the latch 10 closed.

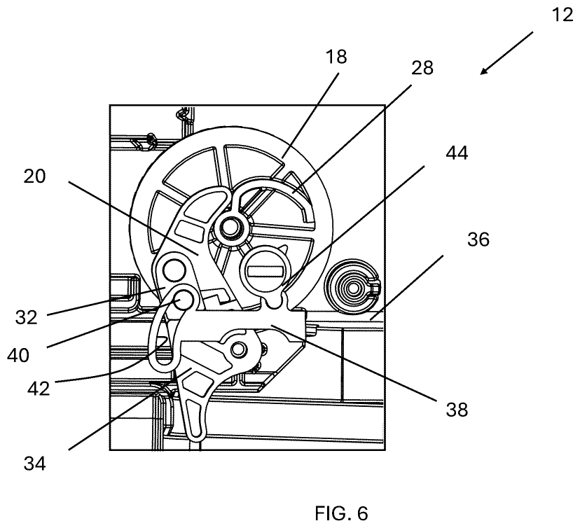

As illustrated, a detent link 32 is pivotally mounted to the power release lever 20, the detent link 32 is capable of being moved between at least an engaged position where the detent link 32 is configured to contact and move a detent lever 34 pivotally mounted to a housing 36 of the latch 10. The detent lever 34 when moved will cause the pawl 22 to move from the engaged position to the disengaged position. In one non-limiting embodiment of the present disclosure, the power release lever 20 is also pivotally mounted to a housing 36 of the latch 10. In one non-limiting embodiment of the present disclosure, the power release lever 20 and the detent lever 34 are configured to pivot about the same axis 37 and portions of the power release lever 20 are located below the detent lever 34 as illustrated in at least FIGS. 6-20.

In one embodiment, movement of the detent link 32 is facilitated by an override lever 38 by virtue of a pin 40 of the detent link 32 that is received in an elongated opening 42 of the override lever 38. Movement of the override lever 38 is facilitated by rotational movement of an override knob 44 operably coupled to the override lever 38. In one embodiment, the override knob 44 or at least a portion thereof is accessible from an exterior of the housing 36 of the latch 10 in order to allow for manual actuation.

In the event of a power loss or a failure in the motor 14 that would render the motor 14 inoperable or bound (e.g., rust in the motor shaft or other adverse conditions) the power release mechanism 12 would jam the mechanism. If this condition happens after power release, then the mechanism would remain in the unlatched position rendering the latch 10 incapable of latching again.

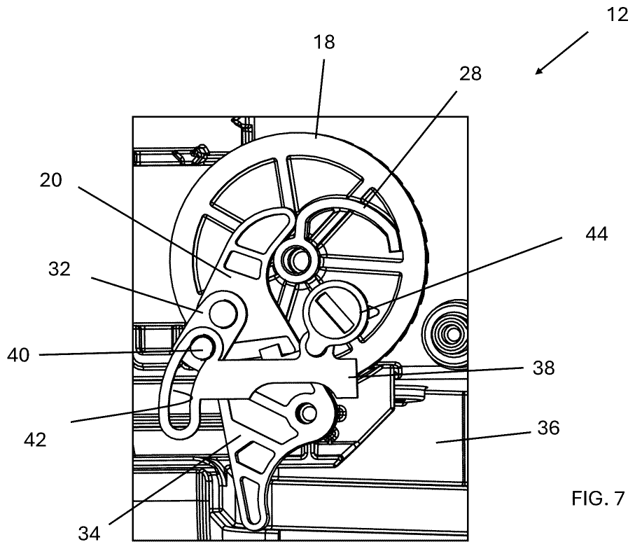

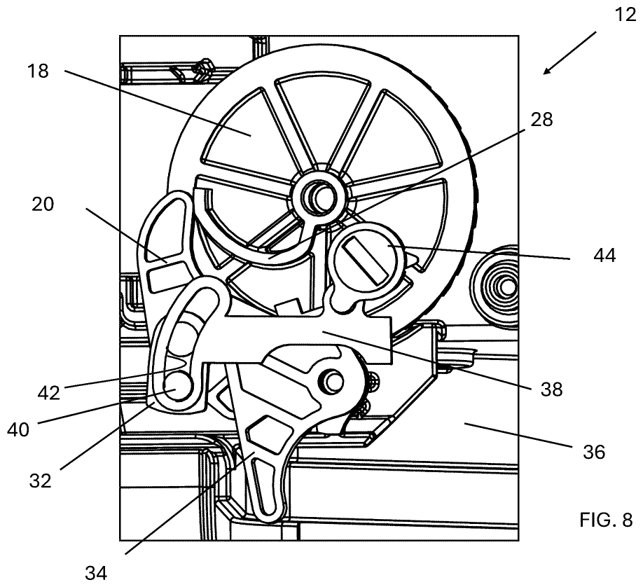

The present disclosure allows for disengagement of the power release chain, through movement of the override lever 38 by virtue of rotation of the override knob 44 which moves the override lever 38 and the detent link 32 into the disengaged position (see at least FIGS. 7 and 8) allowing the levers including the detent lever 34 to return home despite the fact that the motor 14 and gear 18 would be stuck in the end of travel position. As such, the pawl 22 or pawls 21 and 23 can return to positions that would allow for the latch 10 to once again achieve a latched or primary state.

The present disclosure is directed to a detent link 32 that is pivotally mounted to the power release lever 20. This arrangement allows transmission of power from the power release lever 20 to the detent lever 34 or release bellcrank 34 which in turn moves the pawl 22. The detent link 32 is also coupled to the override lever 38 or bypass lever 38 that allows movement in a certain path when power release is activated. When the override lever 38 or bypass lever 38 is moved to a disengaged position the detent link 32 will bypass the detent lever 34 or release bellcrank 34 avoiding the movement of the pawl 22. In one non-limiting embodiment, the override lever 38 or bypass lever 38 is connected or operably coupled to the override knob 44 which will return the detent link 32 to an engaged position (position to contact with the detent lever 34 or release bellcrank 34) when the motor 14 and gear 18 return home. In other words, when the detent link 32 is in the disengaged position, independent movement of the detent lever 34 with respect to the power release lever 20 is possible to allow the latch 10 to once again move into a latched or primary state after a power release wherein the power release mechanism 12 may have inadvertently become stuck in a released state.

Note and for ease of explanation not all of the aforementioned components are illustrated in each of FIGS. 1-8.

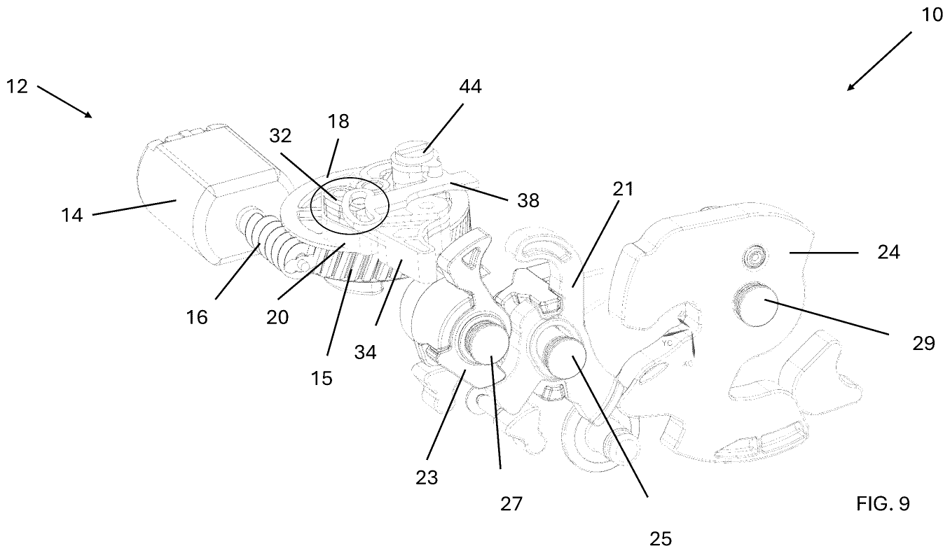

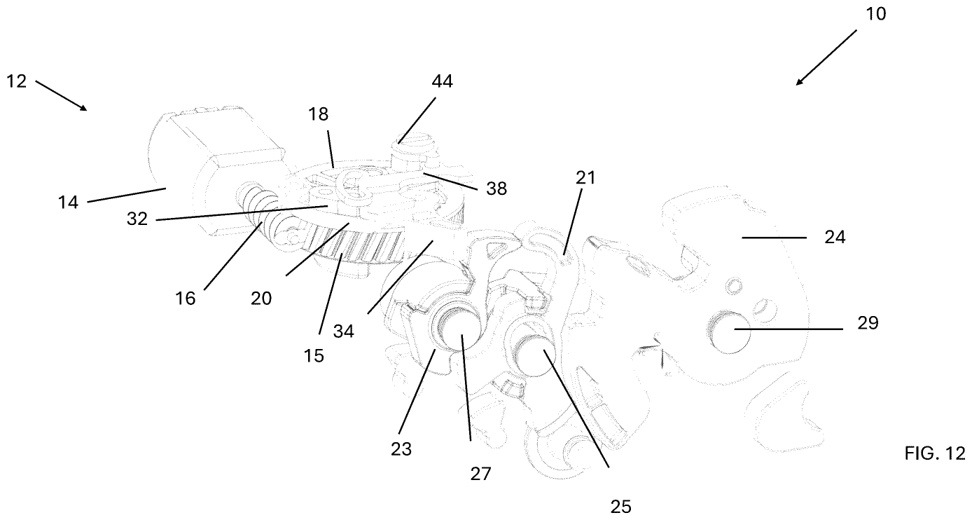

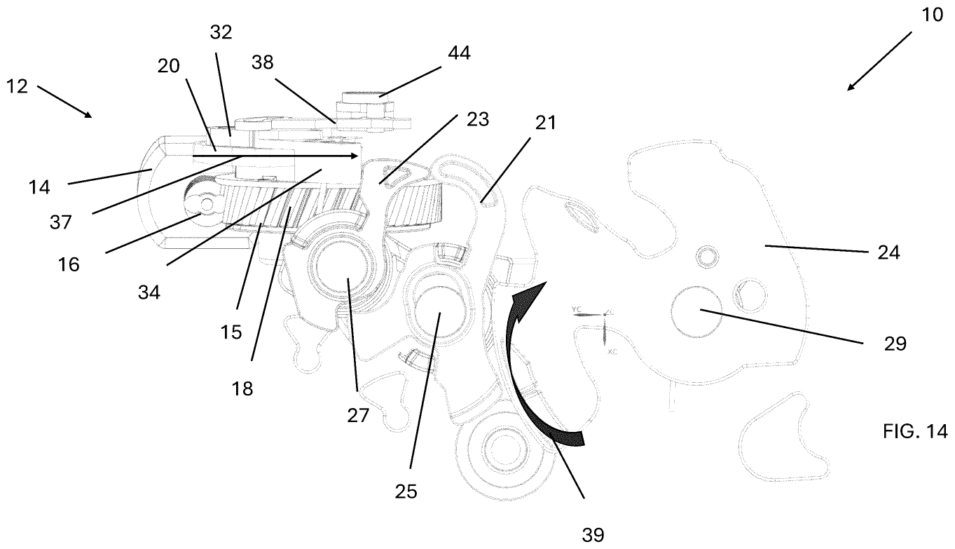

FIGS. 9-20 provide additional views of a vehicle door latch 10, including a power release mechanism 12 for transitioning the vehicle latch 10 from a latched state (see at least FIGS. 9-11) to an unlatched state (See at least FIGS. 12-14) in accordance with the present disclosure. In FIGS. 9-20 the pawl 22 comprises a double pawl namely a primary pawl 21 and a secondary pawl 23 each rotationally or pivotally mounted to the latch 10 or the backing plate 26 of the latch 10 by a respective pivot 25, 27. The secondary pawl 23 being contacted by the detent lever 34 or release bellcrank 34 when it is rotated by the detent link 32 such that the secondary pawl 23 is rotated or pivoted to make contact with primary pawl 21, which maintains that claw 24 in a primary or closed position and when the primary pawl 21 is rotated to a disengaged position the claw 24 is free to rotate to an open position (See at least FIGS. 12 and 14). The claw 24 being pivotally or rotationally mounted to the latch 10 or the backing plate 26 of the latch 10 by a pivot 29.

FIG. 9 is an illustration of the power release mechanism 12 in a home position and in an engaged position. Here the detent link 32 is engaged with the detent lever 34 or release bellcrank 34. If the motor 14 is energized, the detent lever 34 or release bellcrank 34 will be rotated and transmit movement to the secondary pawl 23 and the primary pawl 21 and release the latch 10 by allowing the claw 24 to rotate into the open position (See at least FIGS. 12 and 14).

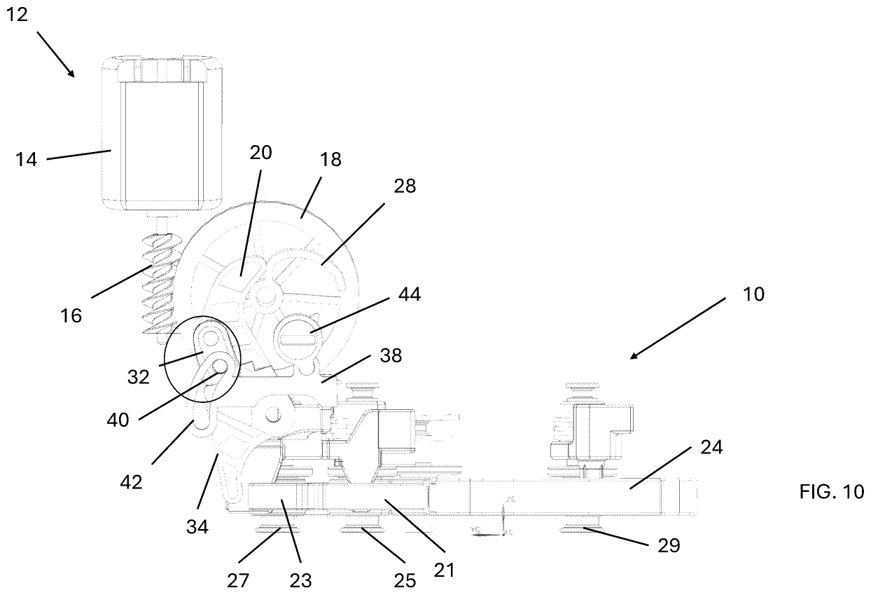

FIG. 10 is an illustration of the power release mechanism 12 in a home position and in an engaged position. If the motor 14 is energized, the cam 28 will transmit movement to the bellcrank or power release lever 20. The fact that the detent link 32 is engaged allows transmission of the rotational movement of the power release gear 18 to the pawls 23, 21 which will release the latch 10.

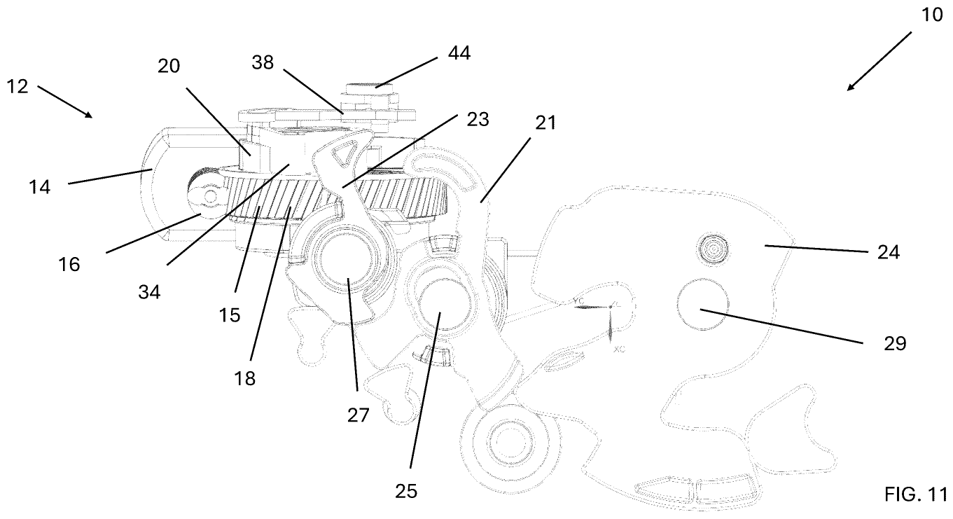

FIG. 11 is an illustration of the power release mechanism 12 in a home position and in a closed position.

FIG. 12 is an illustration of the power release mechanism 12 when the power release mechanism 12 in an engaged position. When the motor 14 is energized and the cam 18 rotates, power is transmitted to the detent lever 34 or release bellcrank 34 or split bellcrank 34 because the release link or detent link 32 is engaged. Power is then transmitted to the pawls 23, 21 which in turn moves to the released position or disengaged position so that the claw 24 can rotate to the open position.

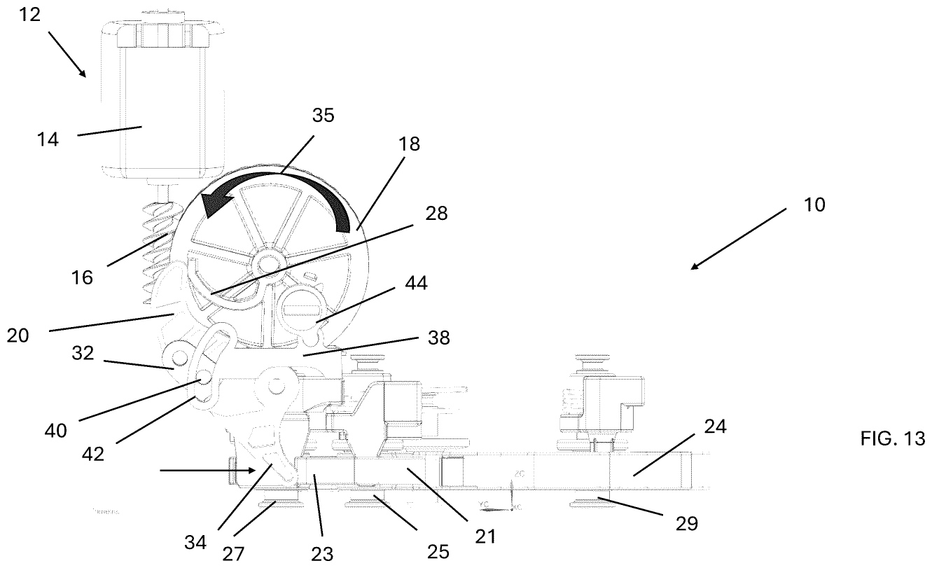

FIG. 13 is an illustration of power release when the power release mechanism 12 in an engaged position. When the gear 18 rotates in the direction of arrow 35 and the cam 28 pushes the bellcrank follower or power release lever 20. Since the release link or detent link 32 is engaged with the detent lever 34 or release bellcrank 34 or split bellcrank 34 it transmits power to the detent lever 34 or release bellcrank 34 or split bellcrank 34 which in turn moves the pawls 23, 21.

FIG. 14 is an illustration of power release when the power release mechanism 12 in an engaged position. When the gear 18 and cam 28 rotate the detent lever 34 or release bellcrank 34 or split bellcrank 34 will transmit power to the pawls 23, 21 in the direction of arrow 37 and the claw 24 is free to rotate in the direction of arrow 39 into the open position illustrated in at least FIG. 14.

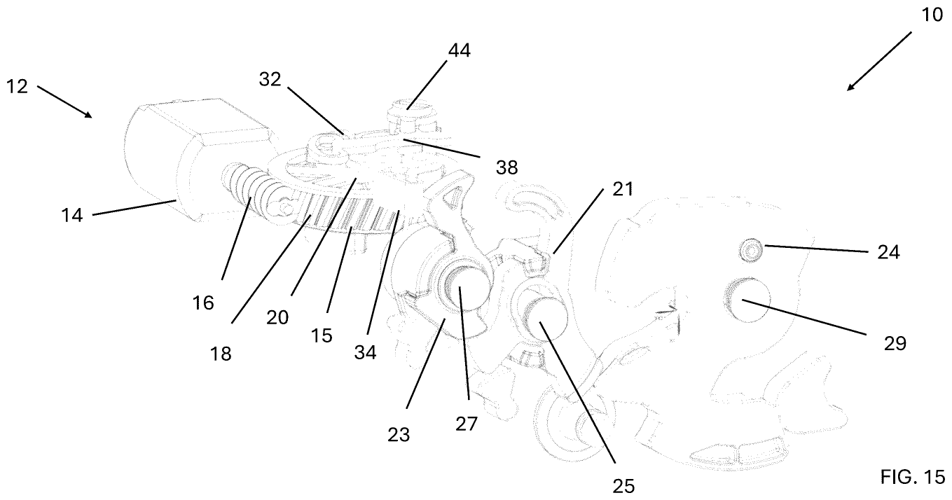

FIG. 15 is an illustration of the power release mechanism 12 in a home and disengaged position. The disengaged release link or detent link 32 will avoid transmission of power to the detent lever 34 or release bellcrank 34 or split bellcrank 34 if the gear 18 and cam 28 are rotated by the motor 14.

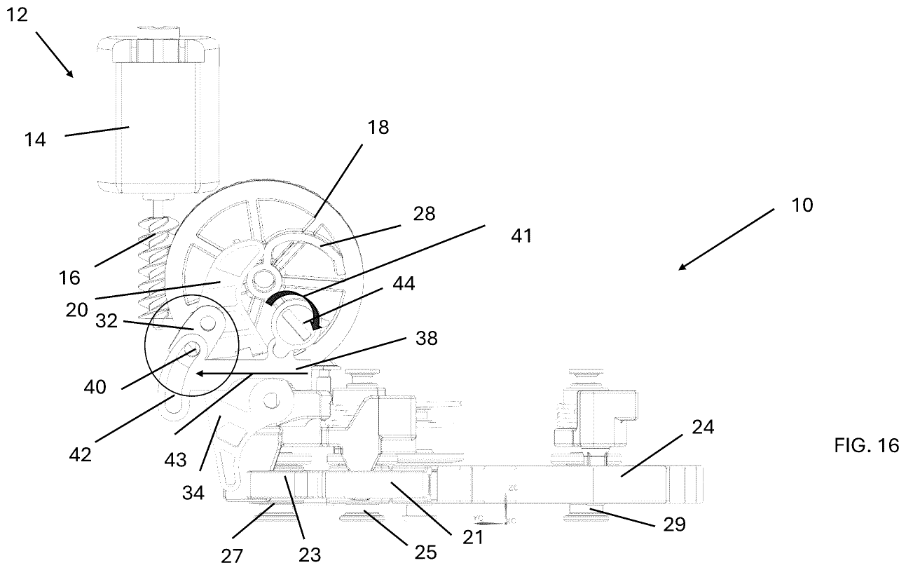

FIG. 16 is an illustration of the power release mechanism 12 in a home and disengaged position. If the motor 14 is energized the gear 18 and cam 28 will rotate and move the bellcrank or power release lever 20 but there will be no transmission of power to the detent lever 34 or release bellcrank 34 or split bellcrank 34 because the release link or detent link 32 is disengaged. The release link or detent link 32 is disengaged when the knob 44 is manually rotated in the direction of arrow 41 and the override lever 38 or bypass lever 38 is moved in the direction of arrow 43 and pin 40 moves the release link or detent link 32 into the disengaged position.

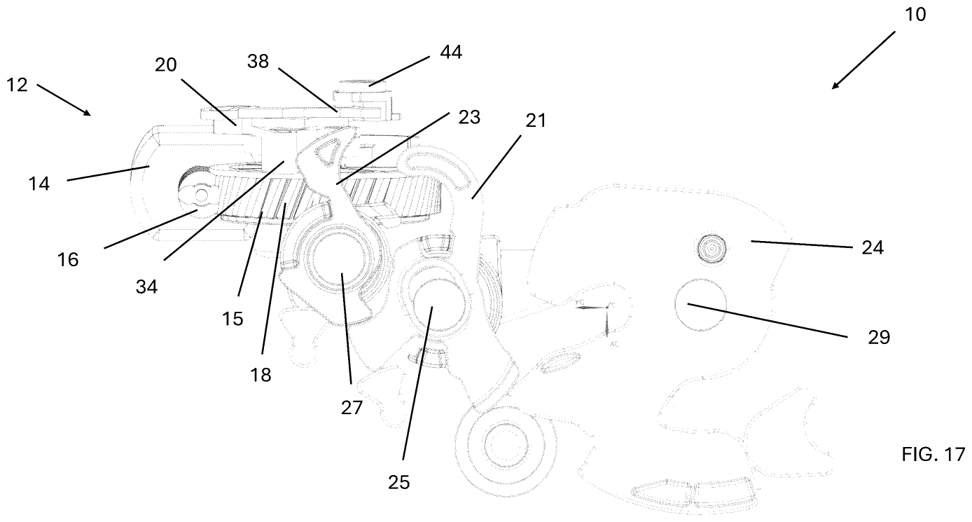

FIG. 17 is an illustration of the power release mechanism 12 in a home position and a disengaged position.

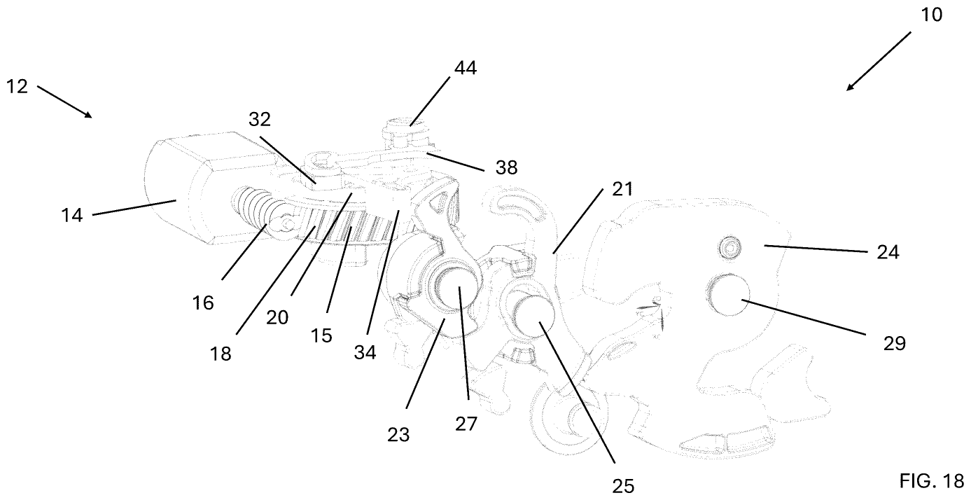

FIG. 18 is an illustration of power release when the power release mechanism 12 in a disengaged position. Here the override lever 38 or bypass lever 38 moved the release link or detent link 32 to the disengaged position.

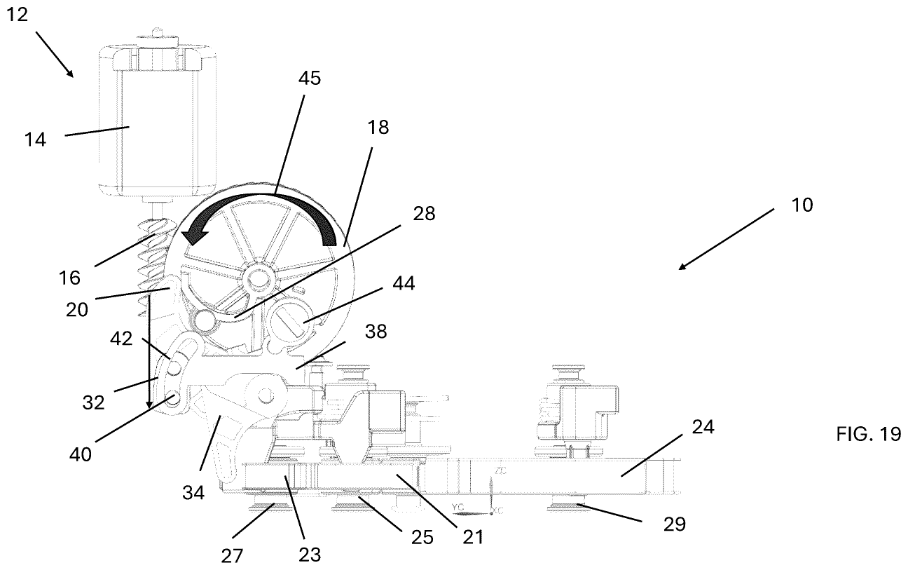

FIG. 19 is an illustration of power release when the power release mechanism 12 in a disengaged position. When the gear 18 and cam 28 rotate in the direction of arrow 45 the power release lever 20 moves in the direction of arrow 47, but since the release link or detent link 32 is disengaged power is not transmitted to the detent lever 34 or release bellcrank 34 or split bellcrank 34 and the detent lever 34 or release bellcrank 34 or split bellcrank 34 does not transmit power to the pawls 23, 21.

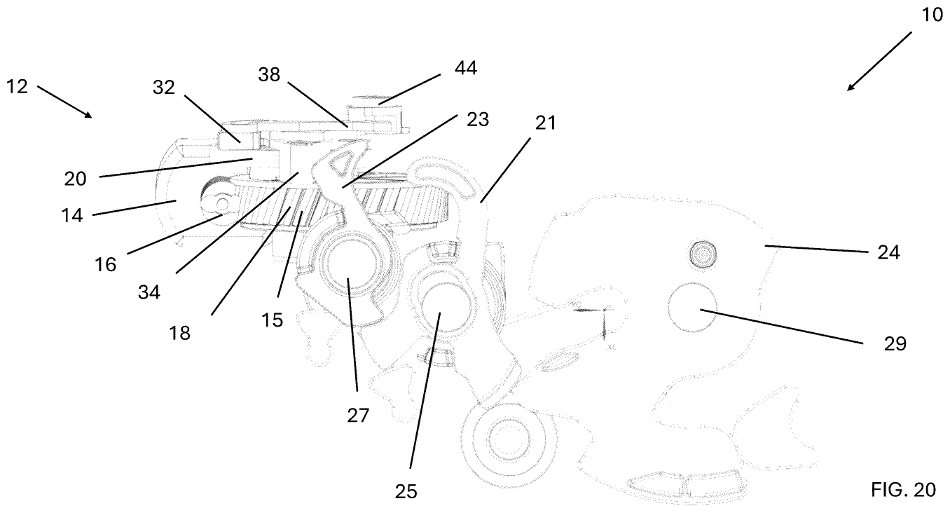

FIG. 20 is an illustration of power release when the power release mechanism 12 in a disengaged position. The pawls 23, 21 remain in the engage positions and there is no power release of the latch 10. This allows the latch 10 to function as a manual latch if the motor 14 binds in the released position.

Also disclosed is a method of disengaging a power release mechanism from a pawl or pawls of a vehicle latch in the event the power release mechanism becomes in operative, including disengaging a detent lever operably coupled to the pawl or pawls of the vehicle latch from a power release lever by moving a detent link rotatably mounted to the power release lever to a disengaged position such that the detent link no longer contacts the detent lever, wherein the detent lever is capable of independent movement with respect to the power release lever when the detent link is in the disengaged position.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A vehicle door latch, comprising:
a power release mechanism for transitioning the vehicle door latch from a latched state to an unlatched state, the power release mechanism including:
a motor that rotates a worm, the worm when rotated, causes rotation of a power release gear, the power release gear when rotated moves and contacts a power release lever that is operably coupled to the power release gear and the power release lever is operably coupled to a pawl of the vehicle door latch, the pawl being configured for movement between an engaged position and a disengaged position, the pawl when in the engaged position prevents a claw of the vehicle door latch from moving from a latched position to an unlatched position and when the pawl is moved to the disengaged position the claw is free to move from the latched position to the unlatched position, the power release gear has a cam surface that moves the power release lever when the power release gear is rotated; and
a detent link pivotally mounted to the power release lever, the detent link capable of being moved between at least an engaged position where it is configured to contact and move a detent lever pivotally mounted to a housing of the latch, the detent lever being operably coupled to the pawl such that movement of the detent lever will cause the pawl to move from the engaged position to the disengaged position, the detent link when in a disengaged position does not contact or move the detent lever.

2. The vehicle door latch as in claim 1, wherein movement of the detent link is facilitated by an override lever that moves a pin of the detent link that is slidably received within an elongated opening of the override lever.

3. The vehicle door latch as in claim 2, wherein movement of the override lever is facilitated by rotational movement of an override knob operably coupled to the override lever.

4. The vehicle door latch as in claim 1, wherein when the detent link is in the disengaged position, the detent lever is capable of independent movement with respect to the power release lever.

5. The vehicle door latch as in claim 4, wherein movement of the detent link is facilitated by an override lever that moves a pin of the detent link that is slidably received within an elongated opening of the override lever and movement of the override lever is facilitated by rotational movement of an override knob operably coupled to the override lever.

6. The vehicle door latch as in claim 1, wherein the power release lever is pivotally mounted to the housing of the vehicle door latch.

7. The vehicle door latch as in claim 6, wherein the power release lever and the detent lever rotate about the same axis.

8. The vehicle door latch as in claim 4, wherein movement of the detent link is facilitated by an override lever that moves a pin of the detent link that is slidably received within an elongated opening of the override lever and movement of the override lever is facilitated by rotational movement of an override knob operably coupled to the override lever and when the detent link is in the disengaged position, the detent lever is capable of independent movement with respect to the power release lever.

9. A power release mechanism for transitioning a vehicle latch from a latched state to an unlatched state, the power release mechanism including:
a power release gear, the power release gear when rotated moves and contacts a power release lever that is operably coupled to the power release gear and the power release lever is operably coupled to a pawl of the vehicle latch, the pawl being configured for movement between an engaged position and disengaged position, the pawl when in the engaged position prevents a claw of the vehicle latch from moving from a latched position to an unlatched position and when the pawl is moved to the disengaged position the claw is free to move from the latched position to the unlatched position, the power release gear has a cam surface that moves the power release lever when the power release gear is rotated; and
a detent link pivotally mounted to the power release lever, the detent link capable of being moved between at least an engaged position where it is configured to contact and move a detent lever, the detent lever being operably coupled to the pawl such that movement of the detent lever will cause the pawl to move from the engaged position to the disengaged position, the detent link when in a disengaged position does not contact or move the detent lever.

10. The power release mechanism as in claim 9, wherein movement of the detent link is facilitated by an override lever that moves a pin of the detent link that is slidably received within an elongated opening of the override lever.

11. The power release mechanism as in claim 10, wherein movement of the override lever is facilitated by rotational movement of an override knob operably coupled to the override lever.

12. The power release mechanism as in claim 9, wherein when the detent link is in the disengaged position, the detent lever is capable of independent movement with respect to the power release lever.

13. The power release mechanism as in claim 12, wherein movement of the detent link is facilitated by an override lever that moves a pin of the detent link that is slidably received within an elongated opening of the override lever and movement of the override lever is facilitated by rotational movement of an override knob operably coupled to the override lever.

14. The power release mechanism as in claim 9, wherein the power release lever and the detent lever rotate about the same axis and movement of the detent link is facilitated by an override lever that moves a pin of the detent link that is slidably received within an elongated opening of the override lever and movement of the override lever is facilitated by rotational movement of an override knob operably coupled to the override lever and when the detent link is in the disengaged position, the detent lever is capable of independent movement with respect to the power release lever.

15. A vehicle door latch, comprising:
a power release mechanism for transitioning the vehicle door latch from a latched state to an unlatched state, the power release mechanism including:
a motor that rotates a worm, the worm when rotated, causes rotation of a power release gear, the power release gear when rotated moves and contacts a power release lever that is operably coupled to the power release gear and the power release lever is operably coupled to one of a primary pawl and a secondary pawl of the latch, the primary pawl being configured for movement between an engaged position and a disengaged position, the primary pawl when in the engaged position prevents a claw of the vehicle door latch from moving from a latched position to an unlatched position and when the primary pawl is moved to the disengaged position the claw is free to move from the latched position to the unlatched position, the power release gear has a cam surface that moves the power release lever when the power release gear is rotated; and
a detent link pivotally mounted to the power release lever, the detent link capable of being moved between at least an engaged position where the detent link is configured to contact and move a detent lever pivotally mounted to a housing of the vehicle door latch, the detent lever being operably coupled to the secondary pawl such that movement of the detent lever will cause the secondary pawl to move the primary pawl from the engaged position to the disengaged position, the detent link when in a disengaged position does not contact or move the detent lever when the power release gear is rotated.

16. The vehicle door latch as in claim 15, wherein movement of the detent link is facilitated by an override lever that moves a pin of the detent link that is slidably received within an elongated opening of the override lever.

17. The vehicle door latch as in claim 16, wherein movement of the override lever is facilitated by rotational movement of an override knob operably coupled to the override lever.

18. The vehicle door latch as in claim 15, wherein when the detent link is in the disengaged position, the detent lever is capable of independent movement with respect to the power release lever.

19. The vehicle door latch as in claim 18, wherein movement of the detent link is facilitated by an override lever that moves a pin of the detent link that is slidably received within an elongated opening of the override lever and movement of the override lever is facilitated by rotational movement of an override knob operably coupled to the override lever.

20. The vehicle door latch as in claim 15, wherein the power release lever is pivotally mounted to the housing of the vehicle door latch and the power release lever and the detent lever rotate about the same axis.
